(19) United States
(12) Patent Application Publication
(10) Pub. No.: US 2026/0319803 A1
(43) Pub. Date: Oct. 15, 2026

(54) COMPUTER SYSTEM HAVING AN INSTRUCTION PROCESSING CIRCUIT DEPLOYING INSTRUCTION HITCHHIKING TO EFFICIENTLY UTILIZE INSTRUCTION PROCESSING CIRCUIT RESOURCES

(71) Applicant: Ampere Computing LLC, Santa Clara, CA (US)

(72) Inventors: Benjamin Crawford Chaffin, Portland, OR (US); Jacob Daniel Morgan, Santa Clara, CA (US)

(21) Appl. No.: 19/177,241

(22) Filed: Apr. 11, 2025

(51) Int. Cl. G06F 9/38; G06F 9/30

(52) U.S. Cl. CPC G06F 9/3856; G06F 9/30054; G06F 9/30079; G06F 9/3814

(57) ABSTRACT

An instruction processing circuit deploying instruction hitchhiking is disclosed. The instruction processing circuit is configured to fetch a plurality of instructions in program order, including a carrier instruction, decode the carrier instruction, and write an entry to a re-order buffer corresponding to the carrier instruction. The instruction processing circuit is also configured to identify a hitchhiking instruction immediately subsequent in program order to the carrier instruction and modify the entry in the re-order buffer corresponding to the carrier instruction to associate the hitchhiking instruction with the carrier instruction. The entry in the re-order buffer associates a hitchhiking instruction that will be considered when the carrier instruction is processed by the instruction processing circuit to advance the program counter based on the carrier instruction and the hitchhiking instruction.

### FIELD OF THE DISCLOSURE

The technology of the disclosure relates to the internal processing of instructions in computing systems that include a central processing unit(s) (CPU(s)) (i.e., processor(s)) and a memory system for storing and accessing data.

### BACKGROUND

An instruction pipeline in a computer system improves processor performance by overlapping the execution of multiple instructions. The instruction pipeline divides the processing of instructions into several sequential stages, such as fetching, decoding, executing, and writing back results. Each stage is handled by one or more dedicated hardware units, allowing multiple instructions to be processed simultaneously at different stages of the pipeline. This parallel processing increases throughput and efficiency, as the processor can potentially complete one instruction per clock cycle when the pipeline is fully utilized. The number of pipeline stages (also referred to as depth) can vary, with some processors having as few as two stages, while others may have over 30 stages. There is a tradeoff between the depth of the instruction pipeline and the amount of throughput desired.

For any pipeline depth, it is desired to conserve hardware units in an instruction pipeline where possible to save resources and reduce power consumption. However, there may be certain instructions that are fetched and processed by the instruction pipeline that are inefficient in utilizing the hardware units.

Instruction fusion techniques are conventional approaches to conserving hardware units. Instruction fusion techniques involve the combination of multiple instructions or micro-operations into a new single micro-instruction. The new single micro-instruction is a more complex micro-operation that can be executed efficiently by the instruction pipeline. The single micro-instruction represents the work needed by the fused macro-instructions. In order for the combination of multiple instructions to be fused, the multiple instructions must be operationally related to each other such as operating on the same data or the output of one instruction (also referred to as producer) is utilized as input to the other instruction (also referred to as a consumer). Implementing instruction fusion techniques requires careful microarchitectural design changes to ensure correctness and efficiency to process the new single micro-instruction. For example, instruction processing resources such as the scheduler, load/store queue, and execution units may have to be re-designed to support instruction fusion requiring extensive cost to implement.

### SUMMARY

Aspects disclosed herein include a computer system having an instruction processing circuit deploying instruction hitchhiking to efficiently utilize instruction processing circuit resources. Related methods and computer-readable media are also disclosed. The computer system includes an instruction processing circuit which includes one or more instruction pipelines. The instruction processing circuit includes hardware circuits at each stage of the instruction pipeline including an instruction fetch circuit, an instruction decode circuit, an execution circuit, and a writeback circuit to process instructions along the instruction processing circuit. When an instruction completes its path through the instruction processing circuit at the writeback circuit, a program counter is advanced to determine how to fetch the next plurality of instructions. The throughput of the instruction processing circuit is dependent on how many hardware circuits are utilized and how each hardware circuit is efficiently utilized. Thus, it is desired to efficiently utilize the hardware circuits.

There are certain types of instructions which conventionally flow through an instruction processing circuit consuming resources in the instruction processing circuit while their intended function or operation need not be handled in an execution circuit. Examples of these instructions include no operation (NOP) instructions and unconditional direct branch instructions. These example instructions only involve a modification of the program counter when processed in the instruction processing circuit. However, these types of instructions are conventionally fully decoded in a decoder circuit, consume their own entry in a re-order buffer, and consume resources through the remaining portion of an instruction pipeline including the execution and writeback circuits, inefficiently allocating these resources because such instructions need not utilize those resources in order to be executed. It has been recognized that because these types of instructions do not consume execution resources in the instruction processing circuit, these types of instructions may be able to be processed in a manner that conserve resources in the instruction processing circuit.

In exemplary aspects, to conserve resources in hardware circuits in the instruction processing circuit for instructions that have an intended function or operation that need not be handled in an execution circuit, an instruction processing circuit includes an instruction fetch circuit configured to fetch a plurality of instructions in program order. The instruction processing circuit also includes a decode circuit which is configured to decode instructions and write entries to a re-order buffer corresponding to instructions. The instruction fetch circuit also includes a predecode circuit prior to the decode circuit which is configured to identify a hitchhiking instruction immediately subsequent in program order to an instruction which is deemed a “carrier” instruction. The predecode circuit is further configured to modify the entry in the re-order buffer corresponding to the carrier instruction to associate the hitchhiking instruction with the carrier instruction. As the carrier instruction proceeds through instruction processing circuit including through the execution circuit, the hitchhiking instruction does not flow through the execution circuit. Rather, the entry in the re-order buffer associates that there is a hitchhiking instruction that will eventually be considered when the carrier instruction is processed by a writeback circuit to advance the program counter based on the carrier instruction and the hitchhiking instruction. As a result, the hitchhiking instruction does not pass through the decode circuit, the execution circuit, or the writeback circuit, advantageously saving utilization of those resources while still maintaining the integrity of the program counter.

In this regard, in one exemplary aspect, a computer system is provided. The computer system comprises a program counter, a re-order buffer, and an instruction processing circuit. The instruction processing circuit includes an instruction fetch circuit configured to fetch a plurality of instructions in program order, the plurality of instructions comprising a carrier instruction. The instruction processing circuit also includes a decode circuit configured to decode the carrier instruction and allocate an entry to the re-order buffer corresponding to the carrier instruction. The instruction fetch circuit comprises a predecode circuit configured to identify a hitchhiking instruction in the plurality of instructions immediately subsequent in program order to the carrier instruction, and, in response to identifying the hitchhiking instruction, modify the entry in the re-order buffer corresponding to the carrier instruction to associate the hitchhiking instruction with the carrier instruction. The instruction processing circuit also includes an execution circuit configured to execute the carrier instruction and a writeback circuit configured to read the entry in the re-order buffer and to advance the program counter based on the carrier instruction and the hitchhiking instruction in response to executing the carrier instruction.

In another exemplary aspect, a method of deploying instruction hitchhiking to efficiently utilize processing circuit resources is provided. The method comprises fetching a plurality of instructions in program order, the plurality of instructions comprising a carrier instruction. The method also comprises decoding the carrier instruction and allocating an entry to a re-order buffer corresponding to the carrier instruction, and identifying a hitchhiking instruction in the plurality of instructions immediately subsequent in program order to the carrier instruction. In response to identifying the hitchhiking instruction, the method also comprises modifying the entry in the re-order buffer corresponding to the carrier instruction to associate the hitchhiking instruction with the carrier instruction, executing the carrier instruction, and reading the entry in the re-order buffer and advancing a program counter based on the carrier instruction and the hitchhiking instruction in response to executing the carrier instruction.

In another exemplary aspect, a non-transitory computer-readable medium is provided. The non-transitory computer-readable medium has stored thereon computer executable instructions which, when executed by a processor, cause the processor to fetch a plurality of instructions in program order, the plurality of instructions comprising a carrier instruction, decode the carrier instruction and allocate an entry to a re-order buffer corresponding to the carrier instruction, and identify a hitchhiking instruction in the plurality of instructions immediately subsequent in program order to the carrier instruction. In response to identifying the hitchhiking instruction, modify the entry in the re-order buffer corresponding to the carrier instruction to associate the hitchhiking instruction with the carrier instruction, execute the carrier instruction, and read the entry in the re-order buffer and advance a program counter based on the carrier instruction and the hitchhiking instruction in response to executing the carrier instruction.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a block diagram of an exemplary computer system including an exemplary instruction processing circuit which deploys instruction hitchhiking to efficiently utilize instruction processing circuit resources;

FIG. 2 is a block diagram of the exemplary computer system of FIG. 1 including the exemplary instruction processing circuit of FIG. 1 which deploys instruction hitchhiking to efficiently utilize instruction processing circuit resources, wherein a hitchhiking instruction is a no operation (NOP) instruction;

FIG. 3 is a block diagram of an exemplary computer system including an exemplary instruction processing circuit which deploys instruction hitchhiking to efficiently utilize instruction processing circuit resources, wherein a hitchhiking instruction is an unconditional branch instruction (B);

FIG. 4 is a flowchart illustrating an exemplary process of deploying instruction hitchhiking to efficiently utilize instruction processing circuit resources in an instruction processing circuit including, but not limited to, the instruction processing circuits pipelines in FIGS. 1-3; and

FIG. 5 is a block diagram of an exemplary computer system that includes a processor that includes a plurality of central processing unit (CPU) cores and peripheral devices and other resources, including a memory system, accessing through an internal coherent fabric bus, wherein the CPU cores include an instruction processing circuit deploying instruction hitchhiking to efficiently utilize instruction processing circuit resources.

### DETAILED DESCRIPTION

Aspects disclosed herein include a computer system having an instruction processing circuit deploying instruction hitchhiking to efficiently utilize instruction processing circuit resources. Related methods and computer-readable media are also disclosed. The computer system includes an instruction processing circuit which includes one or more instruction pipelines. The instruction processing circuit includes hardware circuits at each stage of the instruction pipeline including an instruction fetch circuit, an instruction decode circuit, an execution circuit, and a writeback circuit to process instructions along the instruction processing circuit. When an instruction completes its path through the instruction processing circuit at the writeback circuit, a program counter is advanced to determine how to fetch the next plurality of instructions. The throughput of the instruction processing circuit is dependent on how many hardware circuits are utilized and how each hardware circuit is efficiently utilized. Thus, it is desired to efficiently utilize the hardware circuits.

There are certain types of instructions which conventionally flow through an instruction processing circuit consuming resources in the instruction processing circuit while their intended function or operation need not be handled in an execution circuit. Examples of these instructions include no operation (NOP) instructions and unconditional direct branch instructions. These example instructions only involve a modification of the program counter when processed in the instruction processing circuit. However, these types of instructions are conventionally fully decoded in a decoder circuit, consume their own entry in a re-order buffer, and consume resources through the remaining portion of an instruction pipeline including the execution and writeback circuits, inefficiently allocating these resources because such instructions need not utilize those resources in order to be executed. It has been recognized that because these types of instructions do not consume execution resources in the instruction processing circuit, these types of instructions may be able to be processed in a manner that conserve resources in the instruction processing circuit.

In exemplary aspects, to conserve resources in hardware circuits in the instruction processing circuit for instructions that have an intended function or operation that need not be handled in an execution circuit, an instruction processing circuit includes an instruction fetch circuit configured to fetch a plurality of instructions in program order. The instruction processing circuit also includes a decode circuit which is configured to decode instructions and write entries to a re-order buffer corresponding to instructions. The instruction fetch circuit also includes a predecode circuit prior to the decode circuit which is configured to identify a hitchhiking instruction immediately subsequent in program order to an instruction which is deemed a “carrier” instruction. The predecode circuit is further configured to modify the entry in the re-order buffer corresponding to the carrier instruction to associate the hitchhiking instruction with the carrier instruction. As the carrier instruction proceeds through instruction processing circuit including through the execution circuit, the hitchhiking instruction does not flow through the execution circuit. Rather, the entry in the re-order buffer associates that there is a hitchhiking instruction that will eventually be considered when the carrier instruction is processed by a writeback circuit to advance the program counter based on the carrier instruction and the hitchhiking instruction. As a result, the hitchhiking instruction does not pass through the decode circuit, the execution circuit, or the writeback circuit, advantageously saving utilization of those resources while still maintaining the integrity of the program counter.

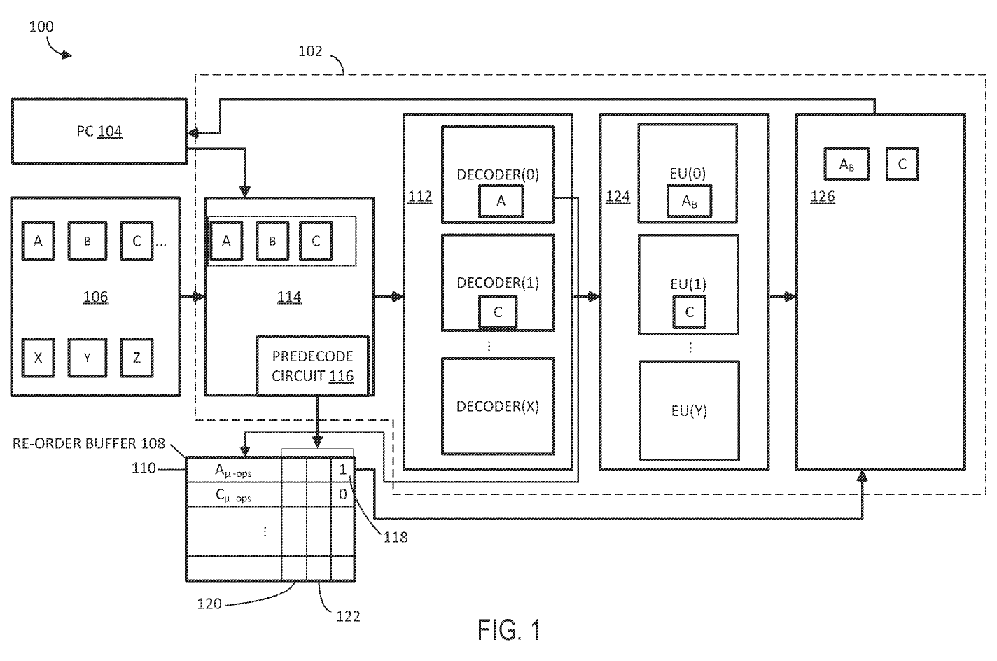

FIG. 1 is a block diagram of an exemplary computer system 100 including an exemplary instruction processing circuit 102 which deploys instruction hitchhiking to efficiently utilize instruction processing circuit resources. The computer system 100 may have one or more instruction processing circuits. Only instruction processing circuit 102 is shown for simplicity. Instruction processing circuit 102 may also be referred to as an instruction pipeline where each of its circuits described below are considered a stage in the instruction pipeline. FIG. 1 illustrates how a plurality of instructions A, B, and C pass through the instruction processing circuit 102 over time.

The computer system 100 also includes a program counter 104 to maintain the address of the next instruction to be processed by the instruction processing circuit 102. The program counter 104 enables the computer system 100 to fetch instructions in the correct order, ensuring proper program execution. The computer system 100 also includes an instruction cache 106 which stores instructions A…Z, for example, for a program that will be fetched by the instruction processing circuit 102. The computer system 100 also includes a re-order buffer (ROB) 108. The ROB 108 is a hardware unit that tracks and manages instructions in the instruction processing circuit 102, allowing out-of-order execution while maintaining in-order architectural completion. The ROB 108 enables the processor to speculatively execute instructions, buffer their results, and commit them to the architectural state in program order, ensuring correct handling of data dependencies and precise exception handling. A ROB entry includes microcode (µ-ops) that represents various information, including, but not limited to, instruction type, destination of the result of an instruction, a value associated with an instruction, and a pipeline stage in which the instruction is currently. A ROB entry is allocated by one of the plurality of decoders decoder(0)-decoder(X) in a decode circuit 112 where X can be an integer. The decode circuit 112 may include the plurality of decoders decoder(0)-decoder(X) and the plurality of instructions may still be processed in order within the decode circuit 112. The plurality of decoders decoder(0)-decoder(X) may be used for a variety of reasons including parallelism, or to allow for specialized decoders that may be more efficient decoding certain types of instructions.

The instruction processing circuit 102 also includes an instruction fetch circuit 114. The instruction fetch circuit 114 is configured to fetch a plurality of instructions in program order (e.g. instructions A, B, and C). Although three instructions are shown as being fetched in FIG. 1 for simplicity, please note that the instruction fetch circuit 114 typically fetches a number of the plurality of instructions which is a power of two. The plurality of instructions includes a carrier instruction A. The decode circuit 112 and, in particular, decoder(0) in this example, decodes carrier instruction A into microcode and allocates ROB entry 110 in ROB 108 to correspond to the carrier instruction A. ROB entry 110 will include microcode A_{µ-ops} for carrier instruction A. The instruction fetch circuit 114 includes a predecode circuit 116. The predecode circuit 116 is configured to identify a hitchhiking instruction B of the plurality of instructions which is immediately subsequent in program order to the carrier instruction A. There is no particular relationship such as data dependency between the hitchhiking instruction B and the carrier instruction A so that the hitchhiking instruction B is identified independent of any relationship with the carrier instruction A.

A hitchhiking instruction B may have one or more of the following characteristics including being an instruction whose processing in the instruction processing circuit 102 does not need to utilize an execution unit, being an instruction whose processing is so minimal that it can be completed in the predecode circuit 116, or being an instruction whose processing in the instruction processing circuit 102 would only cause the program counter 104 to be unconditionally modified. The types of instructions that may have one or more of these characteristics include some program control instructions, exception handling instructions, debugging instructions, and power management instructions. As such, the predecode circuit 116 may be configured to identify the hitchhiking instruction B in the plurality of instructions immediately subsequent in program order to the carrier instruction A, by identifying the hitchhiking instruction B whose operation can be completed in the predecode circuit 116, by identifying the hitchhiking instruction B whose operation in the instruction processing circuit 102 does not need to utilize an execution unit, or by identifying the hitchhiking instruction B whose operation in the instruction processing circuit 102 would only cause the program counter 104 to be unconditionally incremented.

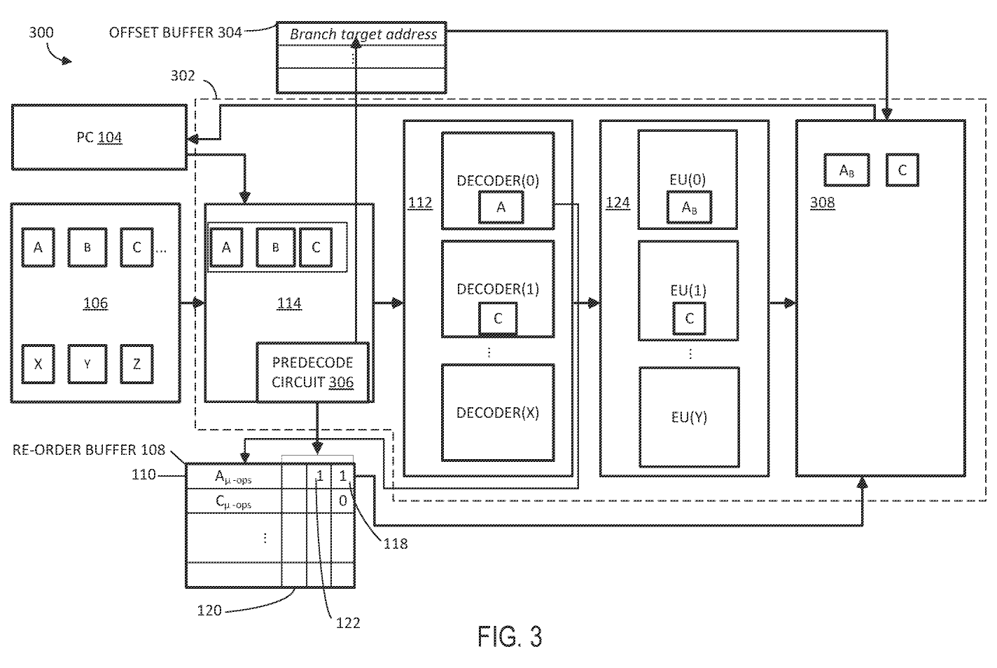

The predecode circuit 116 is configured, in response to predecoding the hitchhiking instruction B, to modify the ROB entry 110 in the ROB 108 corresponding to the carrier instruction A to associate that another instruction is with the carrier instruction A. To associate the hitchhiking instruction B with the carrier instruction A, bit 118 may be set to a particular value indicating that instruction A is serving as a carrier instruction (e.g., a logic “1” in an aspect). Optional field 120 may be included to store the length of hitchhiking instruction B if the plurality of instructions are from an instruction set architecture that supports variable length instructions. Optional bit 122 may be used to indicate if the hitchhiking instruction B requires additional resources which will be discussed in connection with FIG. 3. As seen by the work done above by the decode circuit 112 and the predecode circuit 116, the predecode circuit 116 completes its work in a fraction of the time required for the decode circuit 112 to complete its work. By predecoding the hitchhiking instruction B and not sending it to the decode circuit 112, the time that would have otherwise been spent in the decode circuit 112 decoding the hitchhiking instruction B advantageously reduces usage of the instruction processing circuit 102, thereby increasing the throughput and reducing power consumption of the instruction processing circuit 102.

The instruction processing circuit 102 also includes an execution circuit 124 which includes a plurality of execution units EU(0)-EU(Y) where Y is an integer. Examples of execution units EU(0)-EU(Y) include arithmetic, logical, and other computational circuits required by an instruction. The execution circuit 124 is configured to execute the decoded carrier instruction A_{B}. Please note that the symbol A_{B} where B is in a subscript position in FIG. 1 merely indicates that the ROB entry 110 for carrier instruction A includes an indication of hitchhiking instruction B so the program counter 104 can be updated based on hitchhiking instruction B. It does not mean that hitchhiking instruction B is carried along with instruction A through the execution circuit 124 and the writeback circuit 126, since the hitchhiking instruction B is not consuming lanes through subsequent stages beyond the predecode circuit 116.

The instruction processing circuit 102 also includes a writeback circuit 126. The writeback circuit 126 is responsible for writing the results of executed instructions back to appropriate registers in the computer system 100. The writeback circuit 126 ensures that the changes made during instruction execution are properly stored, allowing subsequent instructions to access the updated values and maintain the correct state of the computer system 100. The writeback circuit 126 is also responsible for advancing the program counter 104. When the writeback circuit 126 processes carrier instruction A, the writeback circuit 126 is configured to read the ROB entry 110 in the ROB 108 to advance the program counter 104 based on the carrier instruction A and the hitchhiking instruction B. In particular, the writeback circuit 126 is configured to read bit 118, and if bit 118 is “1,” the writeback circuit 126 will advance the program counter 104 based on both instruction A and instruction B. If the bit 118 was “0”, there would have been no hitchhiking instruction B associated with carrier instruction A, so the writeback circuit 126 would advance the program counter 104 based only on instruction A.

The instruction processing circuit 102 is shown as having a depth of four stages (instruction fetch, decode, execute, and writeback) for simplicity. However, instruction hitchhiking as described herein also applies to deeper instruction processing circuits having additional stages, and shallower instruction processing circuits having fewer stages. In relative terms, deeper instruction processing circuits may amplify the savings caused by not passing the hitchhiking instruction B beyond the predecode circuit 116, by having more stages subsequent to the predecode circuit 116 in which processing of a hitchhiking instruction may be omitted.

Some constraints may be adopted in the design of the instruction processing circuit 102 to simplify implementation of the instruction processing circuit 102. For example, one such constraint may include limiting carrier instructions to not include conditional branch instructions. In this way, tracking of mispredict paths does not have to be considered by the general technique of hitchhiking instructions with a carrier instruction. Those having skill in the art will appreciate that whether to adopt such constraints, and if so, what constraints to adopt, are matters of engineering and design choice, and do not limit the teachings of the present disclosure.

Unlike conventional instruction fusion techniques, instruction hitchhiking does not combine related instructions. Rather, the instruction fetch circuit 114 identifies a hitchhiking instruction independent of any relationship with the carrier instruction other than the carrier instruction is immediately preceding the hitchhiking instruction in program order, and the hitchhiking instruction is selected based on the lack of work required by the hitchhiking instruction. The hitchhiking instruction merely causes the predecode circuit 116 to update an existing entry in the ROB 108 (the carrier instruction’s entry) and does not proceed through the decode circuit 112 and further through the instruction processing circuit 102. There is no micro-code for the hitchhiking instruction to store or pass through the instruction processing circuit 102, nor is there a need to re-design the decode circuit 112 or the execution circuit 124 to support the hitchhiking instruction.

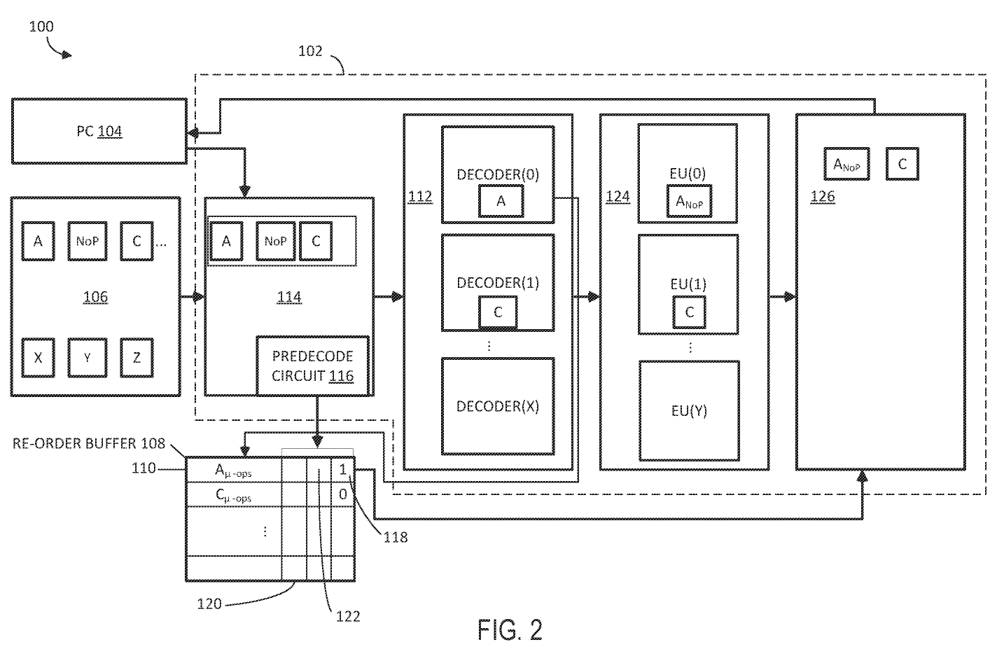

FIG. 2 is a block diagram of the exemplary computer system 100 of FIG. 1 including the exemplary instruction processing circuit 102 of FIG. 1 which deploys instruction hitchhiking to efficiently utilize instruction processing circuit resources, wherein the hitchhiking instruction is a no operation (NOP) instruction. A NOP instruction meets the criteria expressed above in connection with FIG. 1 in that the processing for the NOP instruction by the instruction processing circuit 102 does not need to utilize an execution unit and is relatively minimal so that it can be completed in the predecode circuit. The processing of the NOP instruction by the instruction processing circuit 102 would only cause the program counter 104 to be unconditionally incremented.

In operation, the decode circuit 112 is configured to decode the carrier instruction A from the plurality of fetched instructions A, NOP, and C, and allocate a ROB entry 110 to the ROB 108 corresponding to the carrier instruction A. The predecode circuit 116 is configured to identify the NOP instruction as a hitchhiking instruction in the plurality of instructions (A, NOP, C) immediately subsequent in program order to the carrier instruction A. The predecode circuit 116 may identify the NOP instruction by various means including scanning the fetched instructions and matching an op code for a NOP instruction in the fetched instruction stream. In response to identifying the NOP instruction, the predecode circuit 116 is further configured to modify the ROB entry 110 in the ROB 108 corresponding to the carrier instruction A to associate the NOP instruction with the carrier instruction A. To associate the hitchhiking instruction NOP with the carrier instruction A, bit 118 may be set to a “1.” The execution circuit 124 is configured to execute the decoded carrier instruction A. Please note that the symbol A_{NOP} where NOP is in a subscript position in FIG. 2 merely indicates that the ROB entry 110 for carrier instruction A includes an indication of hitchhiking instruction NOP so the program counter 104 can be updated based on hitchhiking instruction NOP. When the writeback circuit 126 processes carrier instruction A, the writeback circuit 126 is configured to read the ROB entry 110 in the ROB 108 to advance the program counter 104 based on the carrier instruction A and the hitchhiking instruction NOP. In particular, the writeback circuit 126 is configured to read bit 118. Since bit 118 is “1,” the writeback circuit 126 will advance the program counter 104 based on both instruction A and instruction NOP.

FIG. 3 is a block diagram of an exemplary computer system 300 including an exemplary instruction processing circuit 302 which deploys instruction hitchhiking to efficiently utilize instruction processing circuit resources, wherein a hitchhiking instruction is an unconditional branch instruction (B). Common elements between the computer system 100 in FIG. 1 and the computer system 300 in FIG. 3 are shown with common element numbers. When the hitchhiking instruction is identified as an unconditional branch instruction (B), the processing in the predecode circuit 306 is the same as described in the predecode circuit 116 above. Additionally, the predecode circuit 306 is further configured to additionally write to optional bit 122 to indicate that the hitchhiking instruction needs additional resources. The predecode circuit 306 is further configured to determine a branch target address from the unconditional branch instruction B and to write the branch target address to an offset buffer 304. The offset buffer 304 stores the branch target address while the carrier instruction A is processed through the stages of the instruction processing circuit 302. Please note that the symbol A_{B} where B is in a subscript position in FIG. 3 merely indicates that the ROB entry 110 for carrier instruction A includes an indication of hitchhiking instruction B so the program counter 104 can be updated based on hitchhiking instruction B. The offset buffer 304 may be a register, a series of registers, or the like. The processing of the writeback circuit 308 is the same as described for the writeback circuit 126 above. Additionally, the writeback circuit 308, in response to executing the carrier instruction A, is further configured to advance the program counter 104 by the branch target address stored in the offset buffer 304. The writeback circuit 308 can determine that additional resources are necessary by, for example, reading optional bit 122 and then reading the branch target address stored in offset buffer 304.

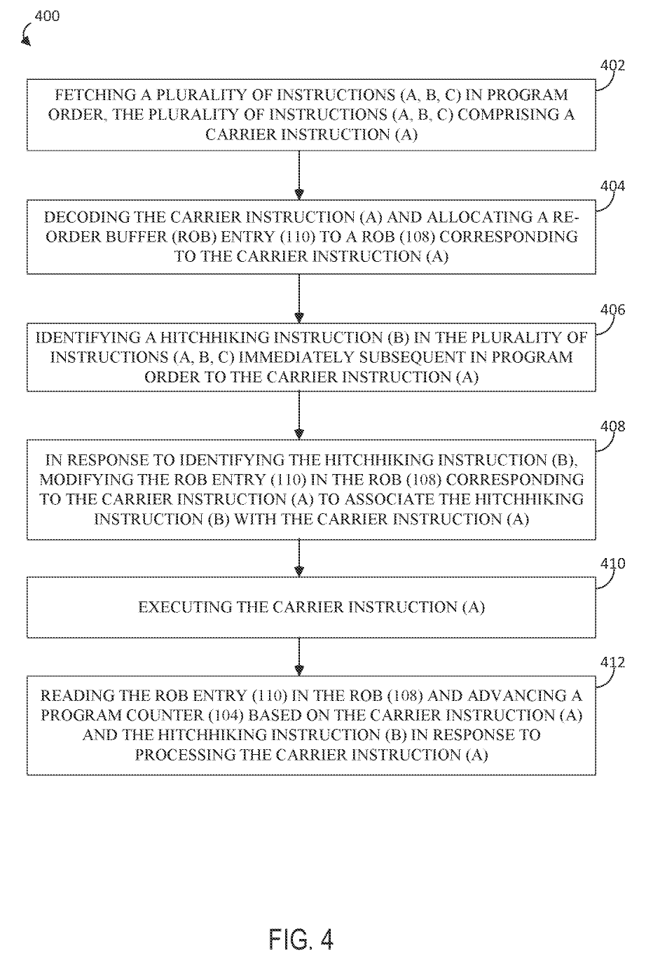

Exemplary computer systems, including an instruction processing circuit which deploys instruction hitchhiking to efficiently utilize instruction processing circuit resources, including, but not limited to, the computer systems described in FIGS. 1-3, can operate through different processes. FIG. 4 is a flowchart illustrating an exemplary process 400 of deploying instruction hitchhiking to efficiently utilize instruction processing circuit resources in an instruction processing circuit including, but not limited to, the instruction processing circuits pipelines in FIGS. 1-3. In this regard, a first exemplary step for deploying instruction hitchhiking can include fetching a plurality of instructions A, B, C in program order, the plurality of instructions A, B, C comprising a carrier instruction A (block 402, FIG. 4). The next step in the process 400 can include decoding the carrier instruction A and allocating a re-order buffer (ROB) entry 110 to a ROB 108 corresponding to the carrier instruction A (block 404, FIG. 4). The next step in the process 400 can include identifying a hitchhiking instruction B in the plurality of instructions A, B, C immediately subsequent in program order to the carrier instruction A (block 406, FIG. 4). The next step in the process 400 can include, in response to identifying the hitchhiking instruction B, modifying the ROB entry 110 in the ROB 108 corresponding to the carrier instruction A to associate the hitchhiking instruction B with the carrier instruction A (block 408, FIG. 4). The next step in the process 400 can include executing the carrier instruction A (block 410, FIG. 4). The next step in the process 400 can include reading the ROB entry 110 in the ROB 108 and advancing a program counter 104 for based on the carrier instruction A and the hitchhiking instruction B in response to executing the carrier instruction A (block 412, FIG. 4).

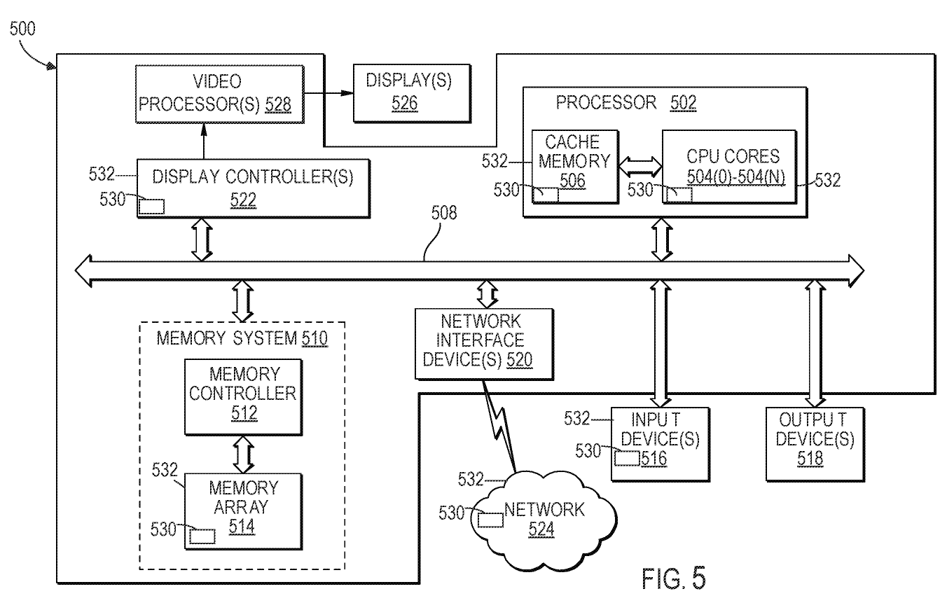

FIG. 5 is a block diagram of an exemplary computer system that includes a processor that includes a plurality of central processing unit (CPU) cores and peripheral devices and other resources, including a memory system, accessing through an internal coherent fabric bus, wherein the CPU cores include an instruction processing circuit deploying instruction hitchhiking to efficiently utilize instruction processing circuit resources.

FIG. 5 illustrates an example of a processor-based system 500 that can be the same or similar to the computer systems 100 and 300 in FIGS. 1-3 as examples. The processor-based system 500 includes a processor 502 that includes the CPU cores 504(0)-504(N). The CPU cores 504(0)-504(N) may include an instruction processing circuit as described in FIGS. 1-3 which may deploy instruction hitchhiking to efficiently utilize instruction processing circuit resources. The processor 502 has a coupled cache memory 506 for rapid access to temporarily stored data. The processor 502 is coupled to a system bus 508 and can intercouple initiator and target devices included in the processor-based system 500. Although not illustrated in FIG. 5, multiple system buses 508 could be provided, wherein each system bus 508 constitutes a different fabric. As is well known, the processor 502 communicates with these other devices by exchanging address, control, and data information over the system bus 508. For example, the processor 502 can communicate memory write and read requests to a memory system 510 as an example of a target device. The memory system 510 includes a memory controller 512 and a memory array 514 that can be provided in one or more memory chips, such as dynamic random-access memory (DRAM) chips for storing primary and/or redundant write data.

Other initiator and target devices can be connected to the system bus 508. As illustrated in FIG. 5, these devices can include one or more input devices 516, one or more output devices 518, one or more network interface devices 520, and one or more display controllers 522, as examples. The input device(s) 516 can include any type of input device, including, but not limited to, input keys, switches, voice processors, etc. The output device(s) 518 can include any type of output device, including, but not limited to, audio, video, other visual indicators, etc. The network interface device(s) 520 can be any devices configured to allow exchange of data to and from a network 524. The network 524 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 520 can be configured to support any type of communications protocol desired.

The processor 502 may also be configured to access the display controller(s) 522 over the system bus 508 to control information sent to one or more displays 526. The display controller(s) 522 sends information to the display(s) 526 to be displayed via one or more video processors 528, which process the information to be displayed into a format suitable for the display(s) 526. The display(s) 526 can include any type of display, including, but not limited to, a cathode ray tube (CRT), a liquid crystal display (LCD), a plasma display, a light emitting diode (LED) display, etc. The processor 502 and its cache memory 506, the memory system 510, the network 524, the input device(s) 516 and/or the display controller(s) 522 can include computer instructions 530 that are non-transitory computer-readable media 532 to control the function of the processor 502, the video processor 528 and the memory system 510 as examples. Any of the functionality described above for the processor 502 including the CPU cores 504(0)-504(N) can be as a result of the instruction processing circuit 102, 302 executing the computer instructions 530.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The initiator devices and target devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of non-transitory computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

What is claimed is:

1. A computing system, comprising:
a program counter;
a re-order buffer; and
an instruction processing circuit, comprising:
an instruction fetch circuit configured to:
fetch a plurality of instructions in program order, the plurality of instructions comprising a carrier instruction; and
a decode circuit configured to decode the carrier instruction and allocate an entry to the re-order buffer corresponding to the carrier instruction;
the instruction fetch circuit comprising a predecode circuit, configured to:
identify a hitchhiking instruction in the plurality of instructions immediately subsequent in program order to the carrier instruction, and
in response to identifying the hitchhiking instruction, modify the entry in the re-order buffer corresponding to the carrier instruction to associate the hitchhiking instruction with the carrier instruction;
an execution circuit configured to execute the carrier instruction; and
a writeback circuit configured to read the entry in the re-order buffer and to advance the program counter based on the carrier instruction and the hitchhiking instruction in response to executing the carrier instruction.

2. The computing system of claim 1, wherein the hitchhiking instruction is not operationally related to the carrier instruction.

3. The computing system of claim 1, wherein:
the predecode circuit is configured to identify the hitchhiking instruction in the plurality of instructions immediately subsequent in program order to the carrier instruction by identifying the hitchhiking instruction as an instruction whose operation can be completed in the predecode circuit.

4. The computing system of claim 3, wherein:
the hitchhiking instruction is the instruction whose processing in the instruction processing circuit does not utilize the decode circuit.

5. The computing system of claim 1, wherein:
the hitchhiking instruction is an instruction whose processing in the instruction processing circuit does not utilize an execution unit.

6. The computing system of claim 1, wherein:
the hitchhiking instruction is an instruction whose processing in the instruction processing circuit would only cause the program counter to be unconditionally incremented.

7. The computing system of claim 1, wherein the hitchhiking instruction is a no operation (NOP) instruction.

8. The computing system of claim 1, further comprising:
an offset buffer, wherein:
the hitchhiking instruction is an unconditional branch instruction; and
the predecode circuit further configured to determine a branch target address from the unconditional branch instruction and to write the branch target address to the offset buffer; and
the writeback circuit configured to advance the program counter by the branch target address stored in the offset buffer.

9. The computing system of claim 1, wherein the hitchhiking instruction is an instruction selected from a group consisting of system control instructions, exception handling instructions, debugging instructions, and power management instructions.

10. The computing system of claim 1, wherein:
the hitchhiking instruction and the carrier instruction do not have a data dependency relationship.

11. A method of deploying instruction hitchhiking to efficiently utilize processing circuit resources, comprising:
fetching a plurality of instructions in program order, the plurality of instructions comprising a carrier instruction;
decoding the carrier instruction and allocating an entry to a re-order buffer corresponding to the carrier instruction;
identifying a hitchhiking instruction in the plurality of instructions immediately subsequent in program order to the carrier instruction;
in response to identifying the hitchhiking instruction, modifying the entry in the re-order buffer corresponding to the carrier instruction to associate the hitchhiking instruction with the carrier instruction;
executing the carrier instruction; and
reading the entry in the re-order buffer and advancing a program counter based on the carrier instruction and the hitchhiking instruction in response to executing the carrier instruction.

12. The method of claim 11, wherein the hitchhiking instruction is not operationally related to the carrier instruction.

13. The method of claim 11, wherein:
identifying the hitchhiking instruction in the plurality of instructions immediately subsequent in program order to the carrier instruction, further comprises:
identifying the hitchhiking instruction as an instruction whose operation can be completed in a predecode circuit.

14. The method of claim 13, wherein:
the hitchhiking instruction is the instruction whose processing in an instruction processing circuit does not utilize a decode circuit.

15. The method of claim 11, wherein:
identifying the hitchhiking instruction in the plurality of instructions immediately subsequent in program order to the carrier instruction, further comprises:
identifying the hitchhiking instruction as an instruction whose processing does not utilize an execution unit.

16. The method of claim 11, wherein:
identifying the hitchhiking instruction in the plurality of instructions immediately subsequent in program order to the carrier instruction, further comprises:
identifying the hitchhiking instruction whose processing would only cause the program counter to be unconditionally incremented.

17. The method of claim 11, wherein the hitchhiking instruction is a no operation (NOP) instruction.

18. The method of claim 11, wherein:
the hitchhiking instruction is an unconditional branch instruction;
modifying the entry in the re-order buffer corresponding to the carrier instruction to associate the hitchhiking instruction with the carrier instruction, further comprises:
determining a branch target address from the unconditional branch instruction and writing the branch target address to an offset buffer; and
reading the entry in the re-order buffer and advancing the program counter based on the carrier instruction and the hitchhiking instruction in response to executing the carrier instruction, further comprises:
advancing the program counter by the branch target address stored in the offset buffer.

19. The method of claim 11, wherein the hitchhiking instruction is an instruction selected from a group comprising system control instructions, exception handling instructions, debugging instructions, and power management instructions.

20. The method of claim 11, wherein:
the hitchhiking instruction and the carrier instruction do not have a data dependency relationship.

21. A non-transitory computer-readable medium having stored thereon computer executable instructions which, when executed by a processor, cause the processor to:
fetch a plurality of instructions in program order, the plurality of instructions comprising a carrier instruction;
decode the carrier instruction and allocate an entry to a re-order buffer corresponding to the carrier instruction;
identify a hitchhiking instruction in the plurality of instructions immediately subsequent in program order to the carrier instruction;
in response to identifying the hitchhiking instruction, modify the entry in the re-order buffer corresponding to the carrier instruction to associate the hitchhiking instruction with the carrier instruction;
execute the carrier instruction; and
read the entry in the re-order buffer and advance a program counter based on the carrier instruction and the hitchhiking instruction in response to executing the carrier instruction.

22. The non-transitory computer-readable medium of claim 21, wherein the hitchhiking instruction is not operationally related to the carrier instruction.

23. The non-transitory computer-readable medium of claim 21, wherein:
identifying the hitchhiking instruction in the plurality of instructions immediately subsequent in program order to the carrier instruction, further comprises:
identifying the hitchhiking instruction whose operation can be completed in a predecode circuit.

24. The non-transitory computer-readable medium of claim 23, wherein:
the hitchhiking instruction does not utilize a decode circuit.

25. The non-transitory computer-readable medium of claim 21, wherein the hitchhiking instruction is an instruction whose processing would only cause the program counter to be unconditionally incremented.
